(19) United States
(12) Patent Application Publication
(10) Pub. No.: US 2022/0273007 A1
(43) Pub. Date: Sep. 1, 2022

(54) FUNCTIONAL FOOD FOR PREVENTING OR IMPROVING DYSURIA

(71) Applicants: MARUHACHI MURAMATSU, INC., Shizuoka (JP); SHIZUOKA PREFECTURAL UNIVERSITY CORPORATION, Shizuoka (JP)

(72) Inventors: Yoshinori HOKARI, Shizuoka (JP); Keita AOSHIMA, Shizuoka (JP); Shizuo YAMADA, Shizuoka (JP); Yoshihiko ITO, Shizuoka (JP)

(21) Appl. No.: 17/633,784

(22) PCT Filed: Aug. 19, 2020
(86) PCT No.: PCT/JP2020/031358

§ 371 Date: Feb. 8, 2022

Related U.S. Application Data
(60) Provisional application No. 62/889,106, filed on Aug. 20, 2019.

(51) Int. Cl. A23L 17/60; A23L 33/10

(52) U.S. Cl. CPC A23L 17/60; A23L 33/10

(57) ABSTRACT

[Problem to be Solved by the Invention] The present invention provides a novel functional supplement/dietary supplement that is inexpensive, abundant, easy to obtain and consume, is capable of preventing and improving voiding dysfunction, and has few side effects.

[Solution] In accordance with one aspect of the present invention, there is provided a functional supplement for preventing or improving voiding dysfunction, characterized by containing a seaweed extract extracted from seaweed using an alcohol solution or water. The voiding dysfunction is caused by benign prostatic hyperplasia or overactive bladder, and the seaweed is one seaweed selected from the group consisting of aosa, aonori, kombu, arame, kajime, wakame, mekabu, hijiki, mozuku, tengusa, dulse, iwanori, and akamoku, with akamoku being especially preferable.

### FIELD OF THE INVENTION

The present invention pertains to a functional supplement, particularly one for preventing or improving voiding dysfunction.

### PRIOR ART

Generally, symptoms associated with voiding dysfunction, or difficulty urinating, appear with increased age due to one cause or another, including genetic factors, diet, obesity, high blood pressure, high blood sugar, dyslipidemia, and so forth. Voiding dysfunction is an impairment of the functioning of the lower urinary tract, which consists of the bladder and urethra (including the prostate in men) and the urethral sphincters. The two main causes of voiding dysfunction are overactive bladder and benign prostatic hyperplasia, with the severity of the symptoms thereof depending upon the individual.

Amidst these circumstances, saw palmetto has been the subject of attention in recent years as an easily consumable dietary supplement that is effective for voiding dysfunction. Saw palmetto fruit extract is well known in Japan as well as in Western countries to be effective for urinary tract symptoms, chronic pelvic pain, bladder dysfunction, loss of libido, hair loss, hormonal imbalance, and prostate cancer, and has been used to treat these conditions.

However, even as domestic demand for saw palmetto increases, bad weather and other factors have resulted in poor harvests for four consecutive years in the Florida peninsula and in Mexico, the main growing regions for saw palmetto, which has destabilized the supply to Japan. This, in turn, has resulted in problems such as rising price.

### PRIOR ART LITERATURE

### Patent Literature

Patent Document 1: JP 2020-078292 A
Patent Document 2: JP 2014-172903 A
Patent Document 3: JP 2014-172902 A
Patent Document 4: JP 2013-066450 A
Patent Document 5: JP H02-203771 A

### BRIEF SUMMARY OF THE INVENTION

### Problem to be Solved by the Invention

The present invention provides a novel functional supplement/dietary supplement that is inexpensive, abundant, easy to obtain and consume, is capable of preventing and improving voiding dysfunction, and has few side effects.

### Means for Solving the Problem

In the course of testing a wide variety of natural materials in order to achieve the abovementioned goal, the inventors focused on akamoku (Sargassum horneri), a type of seaweed, as a material that is inexpensive, abundant, and easy to obtain and consume.

Akamoku, like hijiki (Sargassum fusiforme) and the like, is a perennial brown alga in genus Sargassum, family Sargassaceae, order Fucales, that is widely distributed along the entire coast of Japan apart from the eastern part of Hokkaido, and from the Korean peninsula to China and northern Vietnam. In particular, algae of genus Sargassum are so abundant that there is a region referred to as the “great Atlantic Sargassum belt”.

Akamoku has long been consumed in the local cuisine of the Tōhoku region of northern Japan. Akamoku is known to contain various nutrients, including polysaccharides such as fucoidan and alginic acid, minerals, fucoxanthin, polyunsaturated fatty acids, and polyphenols, and to therefore have pharmacological effects and functions that are beneficial for beauty and health.

Focusing on the abovementioned abundance and multiple functions of akamoku, the inventors theorized that seaweeds, including akamoku, have the potential to exhibit functions that would contribute to the prevention or improvement of voiding dysfunction, and, through careful experimentation, identified the preconditions necessary for such functions to manifest, thereby arriving at the present invention.

Specifically, a primary aspect of the present invention provides the following.

(1) A functional supplement for preventing or improving voiding dysfunction, characterized by containing a seaweed extract.
(2) The supplement according to (1), wherein the voiding dysfunction is caused by benign prostatic hyperplasia or overactive bladder.
(3) The supplement according to (1), wherein the seaweed is one seaweed selected from the group consisting of aosa (Ulva), aonori (green laver), kombu, arame (Eisenia bicyclis), kajime (Ecklonia cava), wakame (Undaria pinnatifida), mekabu (root of the wakame), hijiki (Sargassum fusiforme), mozuku (Nemacystus decipiens), tengusa (red algae in family Gelidiaceae), dulse (Palmaria palmata), iwanori (various species of Pyropia), and akamoku (Sargassum horneri).
(4) The supplement according to (1), wherein the seaweed extract is extracted from a specific seaweed in at least 50% ethanol solution.
(5) The supplement according to (4), wherein the seaweed extract is extracted from a specific seaweed in at least 95% ethanol solution.
(6) The supplement according to (1), wherein the seaweed extract has an extract concentration of 300 μg/mL or greater.
(7) The supplement according to (6), wherein the seaweed extract has an extract concentration of 1 mg/mL or greater.
(8) The supplement according to (1), wherein the seaweed extract has a fucoxanthin concentration of at least 0.5 mg/Kg, an eicosapentaenoic acid concentration of at least 71 μg/mL, and a stearidonic acid concentration of at least 47 μg/mL.
(9) The supplement according to (1), wherein the seaweed extract is water extracted or hot water extracted from a specific seaweed.
(10) The supplement according to (1), wherein the seaweed extract has an extract concentration of 50 mg/mL or greater.

In accordance with the features described above, it is possible to suppress excessive contractions from overactive bladder, inhibit 5α-reductase activity, which is a cause of benign prostatic hyperplasia, and inhibit androgen receptor binding.

As a result of these effects, it is possible to suppress excessive contractions from overactive bladder, and benign prostatic hyperplasia. This yields the effect of making it possible to prevent or improve voiding dysfunction.

In addition, as an effect of the abundance and inexpensiveness of seaweeds such as akamoku, it is possible to mass produce a functional supplement that is safe and free of side effects.

Other characteristics of the present invention will be made apparent in the descriptions of the embodiment of the present invention described below.

This specification refers to several documents, the entire contents of which are incorporated herein by reference.

### BRIEF DESCRIPTION OF THE DRAWINGS

FIG. 1 illustrates steps for processing Japanese akamoku into a functional supplement.

FIG. 2 is a flowchart of a process from obtaining a 95% EtOH (ethanol solution) extract of akamoku (akamoku extract) to purification.

FIG. 3 is a schematic illustration of an organ bath assay for evaluating inhibitory action upon drug-induced contraction of rat bladder smooth muscle.

FIG. 4 shows results for an organ bath assay (1 mg/mL akamoku extract) titled “1 mM ACh contractile inhibition assay”.

FIG. 5 shows organ bath assay results (1 mg/mL akamoku extract) titled “80 mM KCl contractile inhibition assay [left] and 10 mM carbachol contractile inhibition assay [right]”.

FIG. 6 shows results for an organ bath assay (300 μg/mL akamoku extract fraction) titled “80 mM KCl contractile inhibition assay”.

FIG. 7 shows results for an organ bath assay (300 μg/mL akamoku extract fraction) titled “1 mM ACh contractile inhibition assay”.

FIG. 8 shows results for an organ bath assay (100 μg/mL akamoku extract fraction) titled “1 mM ACh contractile inhibition assay”.

FIG. 9 shows results for an organ bath assay (akamoku extract fraction) titled “Cumulative administered ACh contractile inhibition assay”.

FIG. 10A shows results for an organ bath assay (contractile inhibition experiment) using akamoku extract (95% ethanol extract).

FIG. 10B shows results for an organ bath assay (contractile inhibition experiment) using akamoku extract (50% ethanol extract).

FIG. 10C shows results for an organ bath assay (contractile inhibition experiment) using akamoku extract (water extract).

FIG. 11A shows organ bath assay results (contractile inhibition experiment) for 95% ethanol extract of 12 types of seaweed.

FIG. 11B shows organ bath assay results (contractile inhibition experiment) for aqueous extracts of 12 types of seaweed.

FIG. 12 shows organ bath assay results (contractile inhibition experiment for unsaturated fatty acids present in akamoku).

FIG. 13 shows organ bath assay results (contractile inhibition experiment for combinations of substances present in akamoku).

FIG. 14 shows organ bath assay results (dose-comparison contractile inhibition experiment for EPA and stearidonic acid present in akamoku).

FIG. 15 illustrates a process of preparing an acetic-acid-induced pollakiuria model rat for use in in vivo assays.

FIG. 16 shows representative examples of results of effects (cystometry) upon acetic-acid-induced pollakiuria model rats.

FIG. 17A shows results related to maximum intravesical pressure, base pressure, and threshold pressure in an in vivo assay (akamoku extract, 95% ethanol) using acetic-acid-induced pollakiuria model rats.

FIG. 17B shows results related to voiding interval, volume per void, and voiding frequency per unit of time in an in vivo assay (akamoku extract, 95% ethanol) using acetic-acid-induced pollakiuria model rats.

FIG. 18 shows results for an in vivo assay (akamoku extract, 50% ethanol) using acetic-acid-induced pollakiuria model rats.

FIG. 19 shows results for an in vivo assay (akamoku extract, aqueous) using acetic-acid-induced pollakiuria model rats.

FIG. 20 shows results for an in vivo assay (oral administration of akamoku-derived fucoxanthin Fx) using acetic-acid-induced pollakiuria model rats.

FIG. 21 shows results for an in vivo assay (50 mg/kg 95% ethanol extract of akamoku) using CYP-induced pollakiuria (cystitis) model rats.

FIG. 22A shows results for a 5α-reductase inhibitory action experiment (HPLC).

FIG. 22B shows results for a 5α-reductase inhibitory action experiment (HPLC).

FIG. 23 shows results for an androgen receptor (AR) binding inhibitory action experiment.

FIG. 24 shows results for a cellular proliferation suppressant action experiment using human prostate cancer LNCaP.FGC cells.

FIG. 25 shows results for a drug efficacy evaluation experiment using a rat benign prostatic hyperplasia model.

### BEST MODE FOR EMBODYING THE INVENTION

An embodiment of the present invention will be described below with reference to the drawings and tables.

### EMBODIMENT OF THE PRESENT INVENTION

In the course of testing a wide variety of natural materials in order to achieve the abovementioned goal, as discussed above, the inventors focused on akamoku (Sargassum horneri), a type of seaweed, as a material that is inexpensive, abundant, and easy to obtain and consume.

Akamoku, like hijiki (Sargassum fusiforme) and the like, is a perennial brown alga in genus Sargassum, family Sargassaceae, order Fucales, that is widely distributed along the entire coast of Japan apart from the eastern part of Hokkaido, and from the Korean peninsula to China and northern Vietnam. In particular, algae of genus Sargassum are so abundant that there is a region referred to as the “great Atlantic Sargassum belt”.

Akamoku is known to contain various nutrients, including polysaccharides such as fucoidan and alginic acid, minerals, fucoxanthin, polyunsaturated fatty acids, and polyphenols, and to have pharmacological effects and functions that are good for beauty and health.

Focusing on the abovementioned abundance and multiple functions of akamoku, the inventors theorized that seaweeds, including akamoku, have the potential to exhibit functions that would contribute to the prevention or improvement of voiding dysfunction—in particular, the potential to act upon overactive bladder and benign prostatic hyperplasia, two major causes of voiding dysfunction—and, through careful experimentation, identified the preconditions necessary for such functions to manifest, thereby arriving at the present invention.

In order to explain the features and functions of the present invention, the two major causes of voiding dysfunction will first be explained.

### (Overactive Bladder)

As discussed above, overactive bladder is one of two major causes of voiding dysfunction.

Voiding dysfunction caused by overactive bladder can be neuropathic or non-neuropathic, i.e., arising from non-neurological causes. In the former case, problems arise in the circuits of the nerves of the brain and the muscles of the bladder (urethra), potentially leading to voiding dysfunction, as a result of neuropathies of the brain such as cerebrovascular disease, Parkinson's disease, multiple system atrophy, or dementia, or neuropathies of the spinal cord such as spinal cord injury, multiple sclerosis, or spinocerebellar degeneration. Voiding dysfunction may also develop as a complication of the abovementioned benign prostatic hyperplasia, loss of pelvic floor muscle strength due to childbirth or the like, and so forth.

Anti-cholines, β3 adrenergic receptor agonists, and the like, which control the contraction and relaxation of the bladder, are generally used to treat these conditions. However, anti-cholines have side effects such as dry mouth, constipation, and accommodative dysfunction, and β3 adrenergic receptor agonists have age restrictions that contraindicate administration to patients of reproductive age.

### (Benign Prostatic Hyperplasia)

Benign prostatic hyperplasia is another of the two major causes of voiding dysfunction. Because the prostate encircles the urethra, enlargement of the prostate as a result of benign prostatic hyperplasia constricts the urethra, leading to voiding dysfunction. Testosterone, one of the male hormones, is converted to dihydrotestosterone by 5α-reductases, which is more potent and causes enlargement of the prostate, and the binding of this dihydrotestosterone to androgen receptors (ARs) can cause enlargement of the prostate through repeated excessive prostate cell proliferation.

Therefore, research is currently underway into 5α-reductase-inhibiting therapeutic agents, such as 5α-reductase inhibitors, and therapeutic agents, such as anti-androgens, and methods that work to inhibit binding between androgen receptors and dihydrotestosterone (DHT). At present, however, these therapeutic agents must be taken internally for extended periods, and are recognized as having side effects such as impaired sexual function caused by reduced serum testosterone levels.

### The Present Invention

In response to these circumstances, the inventors focused on specific abundant and inexpensively obtainable seaweeds, discovered that extracts thereof exhibit the function of inhibiting bladder contraction in specific conditions and have the 5α-reductase-inhibiting function of 5α-reductase inhibitors and the like, and empirically confirmed the same, thereby arriving at the present invention.

Specifically, the present invention is a functional supplement for preventing or improving voiding dysfunction, characterized by containing a seaweed extract.

In accordance with a first embodiment of the present invention, the seaweed extract is obtained through extraction from seaweed using an ethanol solution of a specific concentration. This seaweed is preferably akamoku. The concentration of the ethanol solution used to perform extraction is 50%, more preferably 90% or higher, and the extract concentration is preferably 300 μg/mL, more preferably 1 mg/mL.

The functional supplement according to this first embodiment may be produced, for example, as follows.

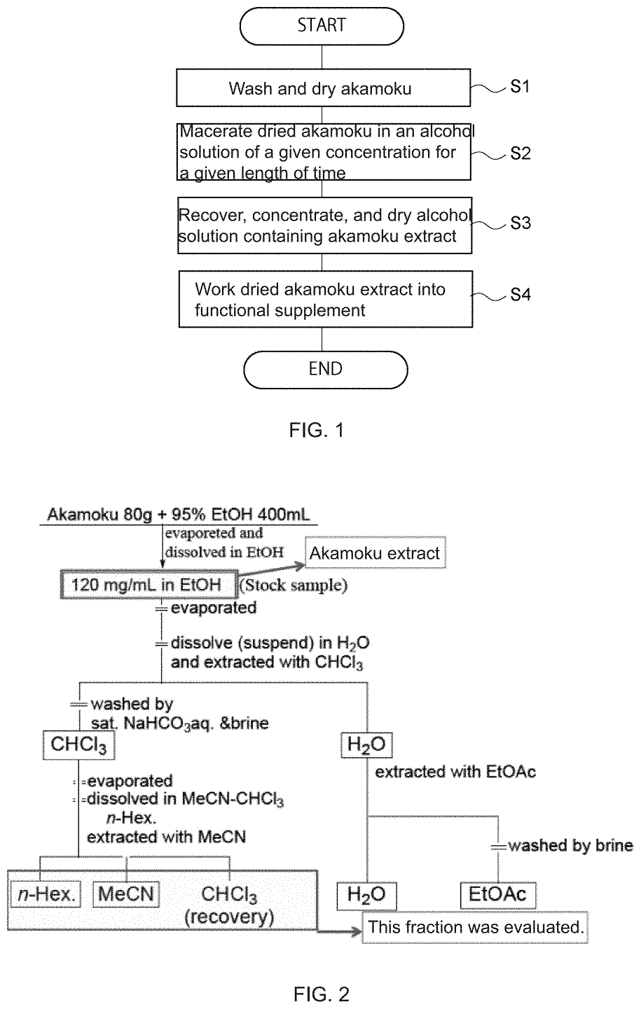

In this embodiment, an example in which Japanese akamoku is used will be described with reference to the flowchart of FIG. 1.

First, 3.6 kg of Japanese akamoku is immersed overnight (16 hours) in 72 L of tap water, then desalinated while being rinsed with tap water. The seaweed is then fan-dried at room temperature to a water content of 10% or less.

Next, the dried akamoku is submerged in a fivefold volume of 95% ethanol solution or a twentyfold volume of 50% ethanol solution, and extraction is performed through maceration or agitation. Extraction is performed at room temperature for one to sixteen hours. The volume of the recovered extract solution is then reduced fiftyfold or more using a vacuum concentrator, after which the solvent is removed using a centrifugal vacuum concentrator to recover an ethanol extract of akamoku.

In this embodiment, the recovered ethanol extract of akamoku is sealed without further modification in a container to create a functional supplement.

However, the functional supplement is not limited to such a form, and the ethanol extract of akamoku produced as described above may be diluted and dissolved in vegetable oil or the like, and worked into a form such as a softgel to create a functional supplement.

A second embodiment of the present invention may be produced as follows.

Japanese akamoku is submerged in a twentyfold volume of tap water, and extraction is performed via maceration or agitation. Extraction is performed in water (room temperature) or hot water (70-90° C.) from one hour to overnight. The volume of the recovered extract solution is reduced fiftyfold or more using a vacuum concentrator, after which the solution is dried using a centrifugal vacuum concentrator, a freeze dryer, or a spray dryer, and an aqueous (hot water) extract of akamoku is recovered.

In this embodiment, the recovered aqueous (hot water) extract of akamoku is sealed without further modification in a container to create a functional supplement.

However, the functional supplement is not limited to such a form, and the water (hot water) extract of akamoku produced as described above may be worked into tablets or capsules, or, taking advantage of the water-soluble properties of the extract, into a form such as a soft drink, jelly, or the like to create a functional supplement.

Experiments conducted in order to determine whether a functional supplement containing the akamoku extract produced as described above is effective against overactive bladder and benign prostatic hyperplasia, as well as the results of said experiments, will be described below.

### [Experiment 1] Extraction of Akamoku Extract, and Preparations for Efficacy Evaluation

In experiment 1, a 95% EtOH (ethanol solution) extract of akamoku (akamoku extract) was first obtained according to the flowchart shown in FIG. 2 in order to perform an efficacy evaluation of whether components present in akamoku effectively act upon overactive bladder.

For the sake of the further extract analysis to be described below, lipid-soluble n-Hex (n-hexane), MeCN (acetonitrile), and CHCL₃ (chloroform) recovery (redissolves insolubles) fractions were obtained via partial purification.

[Experiment 2] Organ Bath Assay (1 mg/mL Akamoku Extract): 1 mM ACh Contractile Inhibition Assay

In experiment 2, an in vitro assay was performed using an organ bath for evaluating contractile/relaxant action to investigate the effects of akamoku extract upon acetylcholine (ACh) induced contraction.

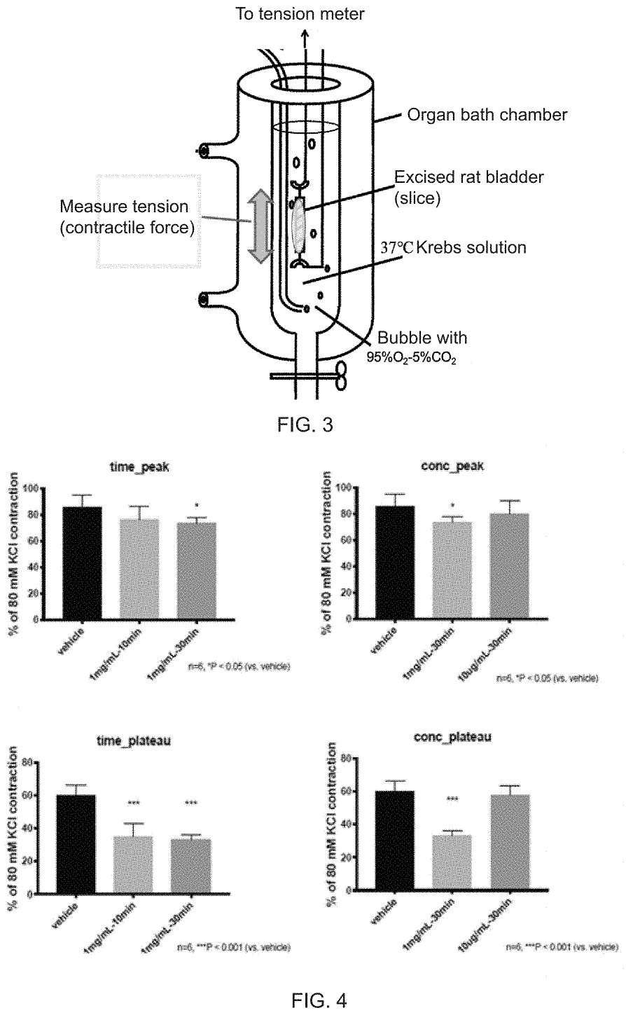

As shown in FIG. 3, a slice of rat bladder smooth muscle was prepared and set in the center of an organ bath chamber. The akamoku extract obtained in experiment 1 was added to the organ bath tank, and, after 30 minutes, 1 mM ACh was added to cause contraction. In this experiment, the concentration of the akamoku extract and the time the extract was left standing were altered to investigate the optimal concentration and time to result in action against contraction.

In the two graphs on the left in FIG. 4, the x-axis represents contractile inhibition by time difference between peak and plateau phase for a control, 10 minutes 1 mg/mL akamoku extract, and 30 minutes 1 mg/mL akamoku extract. In the two graphs on the right in FIG. 4, the x-axis indicates degree of contractile inhibition by difference in akamoku extract concentration between peak and plateau phase for a control, 30 minutes 1 mg/mL akamoku extract, and 30 minutes 10 μg/mL akamoku extract.

From the results, it was found that 30 minutes of 1 mg/mL of the akamoku extract obtained in experiment 1 most significantly inhibited 1 mM ACh (acetylcholine) contraction.

[Experiment 3] Organ Bath Assay Results (1 mg/mL Akamoku Extract): 80 mM KCl Contractile Inhibition Assay, 10 mM Carbachol Contractile Inhibition Assay

Next, 1 mg/mL akamoku extract was added to the organ bath tank, and 80 mM KCl and 10 mM carbachol, which promotes further acetylcholine induction, were separately added after five minutes and thirty minutes, respectively, to induce contraction in order to investigate the suppressant effects of the akamoku extract in the presence of stronger contraction.

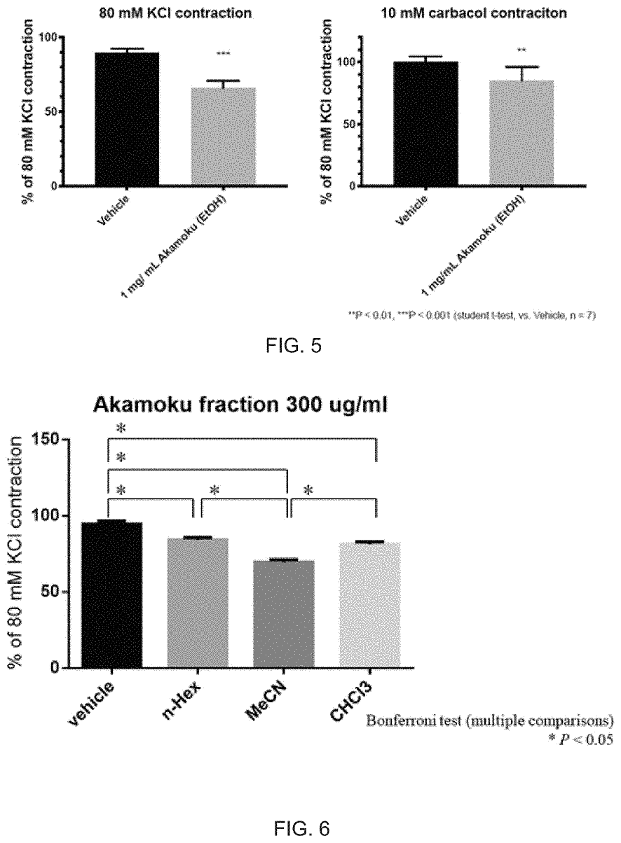

FIG. 5 shows a comparison of the contractile inhibition of 1 mg/mL akamoku extract upon contraction induced by 80 mM KCl in the left graph, and the contractile inhibition of 1 mg/mL akamoku extract upon contraction induced by 10 mM carbachol in the right graph.

As shown in FIG. 5, it was found that 1 mg/mL of the akamoku extract from experiment 1 significantly inhibited contraction, even when said contraction was promoted through the addition of 10 mM carbachol.

[Experiment 4] Organ Bath Assay Results (300 μg/mL Akamoku Extract Fraction): 80 mM KCl Contractile Inhibition Assay

In experiment 4, the contractile-inhibitory action of the lipid-soluble n-Hex (n-hexane), MeCN (acetonitrile), and CHCL₃ (chloroform) recovery (redissolves insolubles) fractions (respective concentrations: 300 μg/mL) partially purified from the akamoku extract in experiment 1 was investigated.

In FIG. 6, the x-axis compares the contractile inhibition of a control and n-Hex (n-hexane), MeCN (acetonitrile), and CHCL₃ (chloroform) recovery (redissolves insolubles) fractions, and the y-axis represents percentage of 80 mM KCl contraction.

The results show that, out of the abovementioned fractions of the akamoku extract, the MeCN (acetonitrile) fraction significantly inhibits contraction.

[Experiment 5] Organ Bath Assay Results (300 μg/mL Akamoku Extract Fraction): 1 mM ACh Contractile Inhibition Assay

In experiment 5, the n-Hex (n-hexane), MeCN (acetonitrile), and CHCL₃ (chloroform) recovery (redissolves insolubles) fractions (respective concentrations: 300 μg/mL) of the akamoku extract were observed for fixed periods, in addition to the inquiry performed in experiment 4, to investigate in which phase in particular there is effective contractile-inhibitory action.

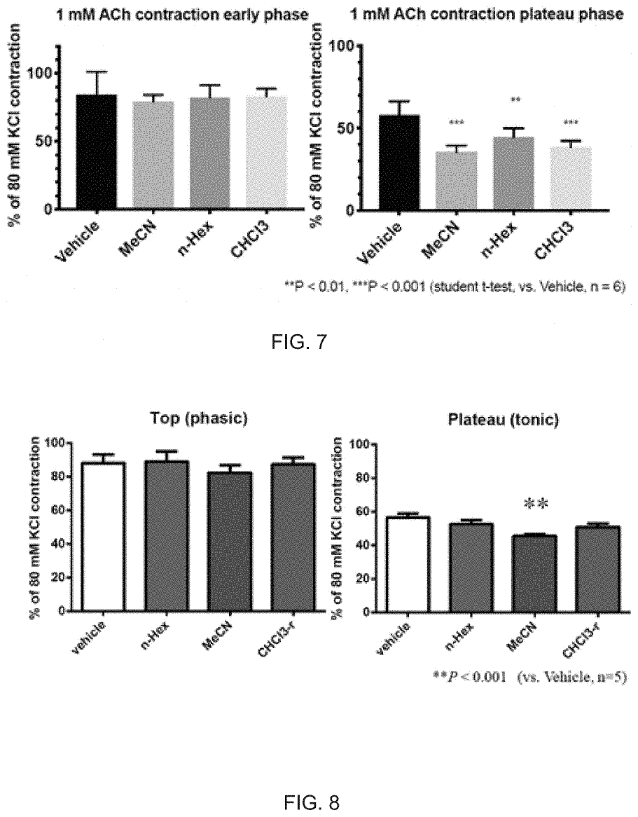

In FIG. 7, the x-axis compares the contractile inhibition of a control and n-Hex (n-hexane), MeCN (acetonitrile), and CHCL₃ (chloroform) recovery (redissolves insolubles) fractions in the early phase in the graph on the left, and in the plateau phase in the graph on the right. The y-axis represents percentage of 80 mM KCl contraction.

The results show that contraction was more significantly inhibited in the plateau (tonic) phase in particular than in the early phase, as shown in the graphs in FIG. 7. Among the various fractions, contraction was significantly inhibited in the plateau (tonic) phase of the MeCN (acetonitrile) fraction in particular.

[Experiment 6] Organ Bath Assay Results (100 μg/mL Akamoku Extract Fraction): 1 mM ACh Contractile Inhibition Assay

For experiment 6, the same experiment as in experiment 5 was performed, apart from altering the concentration of the akamoku extract fraction in experiment 5 from 300 μg/mL to 100 μg/mL to investigate what sort of differences would occur in the plateau phase.

As a result, as in experiment 5, plateau (tonic) phase contraction was significantly inhibited, as shown in the graphs in FIG. 8. Among the various fractions, contraction was significantly inhibited in the plateau (tonic) phase of the MeCN (acetonitrile) fraction in particular.

### [Experiment 7] Organ Bath Assay Results (Akamoku Extract Fraction): Cumulative Administered ACh Contractile Inhibition Assay

On the basis of the results from experiments 5 and 6, a comparison was performed of the MeCN (acetonitrile) fraction, which most significantly inhibited contraction among the three fractions, at concentrations of 100 μg/mL, 300 μg/mL, and 1 mg/mL.

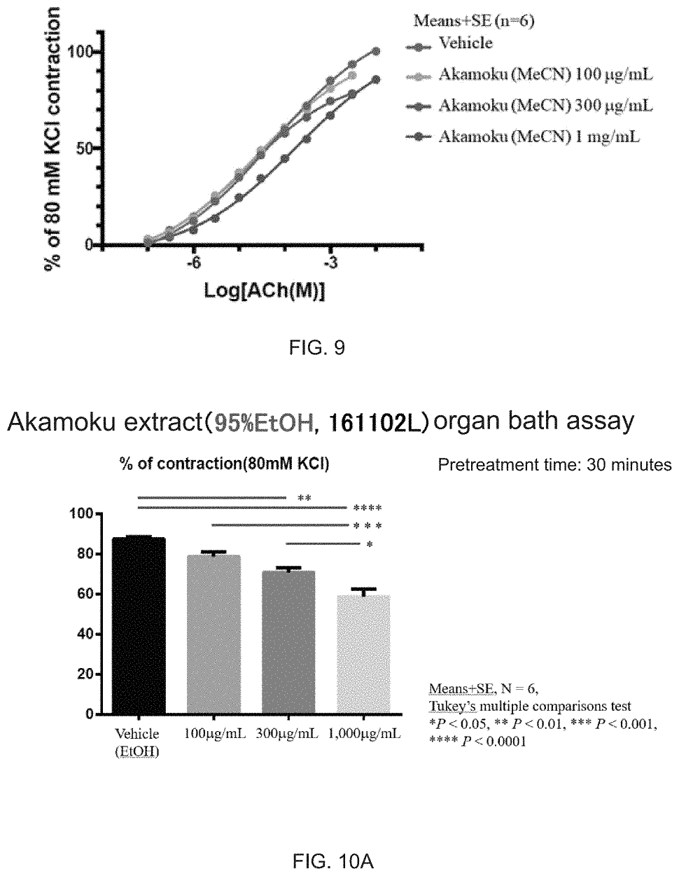

As shown in FIG. 9, the ACh concentration reaction curves of the MeCN fractions are concentration-dependently shifted right. From this, it was ascertained that contraction is more significantly inhibited as the concentration of the MeCN (acetonitrile) fraction increases.

### [Experiment 8] Organ Bath Assay (Contractile Inhibition Experiment): Extraction Ethanol Concentration Investigatory Experiment

On the basis of an in vitro assay using an organ bath for evaluating contractile/relaxant action similar to that described above, akamoku extracts (95% ethanol extract, 50% ethanol extract, and aqueous extract, respectively) were added to the organ bath tank in concentrations of 100 μg/mL, 300 μg/mL, and 1,000 μg/mL, and, after 30 minutes, 80 mM KCl, a contraction inducer, was added to induce contraction. Subsequently, the tension (contractile force) of slices of rat bladder smooth muscle was measured, and contraction-inhibiting effects were evaluated by respective ethanol concentration and extract concentration to investigate the optimal concentration at which contraction was significantly suppressed.

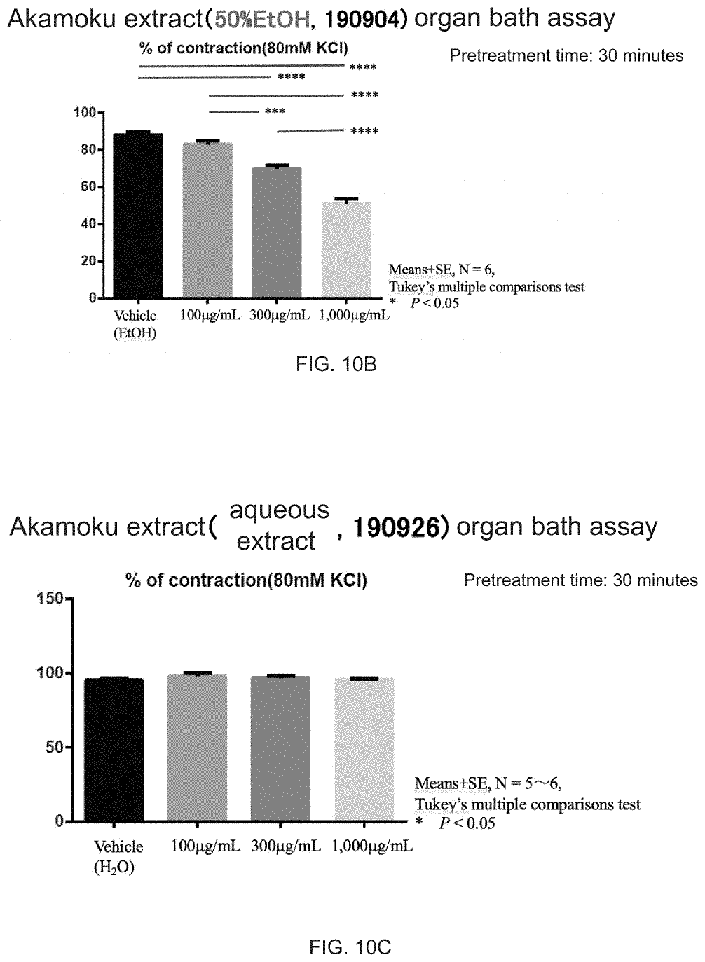

FIGS. 10A-10C show results for contractile inhibition experiments performed using organ bath assays. In the graphs in FIGS. 10A-10C, the x-axis shows unadulterated ethanol as a control and 100 μg, 300 μg/mL, and 1,000 μg/mL akamoku extracts, and the y-axis shows the percentage of contraction induced by 80 mM KCl.

As shown in FIG. 10A, the 95% ethanol extract of akamoku yielded significant inhibition at concentrations of 300 μg/mL and 1,000 μg/mL.

As shown in FIG. 10B, the 50% ethanol extract of akamoku yielded significant inhibition at concentrations of 300 μg/mL and 1,000 μg/mL.

### [Experiment 9] Organ Bath Assay (Contractile Inhibition Experiment for 95% Ethanol Extracts and Aqueous Extracts of 12 Seaweed Types)

This experiment investigates the action of other seaweed extracts upon overactive bladder through in vitro organ bath assays.

Along with akamoku, the seaweeds that were tested are aosa and aonori, which are green algae; kombu, arame, kajime, wakame, mekabu, hijiki, and mozuku, which are brown algae; and tengusa, dulse, and iwanori (susabinori; Neopyropia yezoensis, asakusanori; Neopyropia tenera), which are red algae. 1 mg/mL extracts of the various seaweeds in 95% ethanol or water were used. 80 mM KCl, a contraction inducer, was also added to induce contraction. The tension (contractile force) of slices of rat bladder smooth muscle was then measured to evaluate contraction inhibition effects.

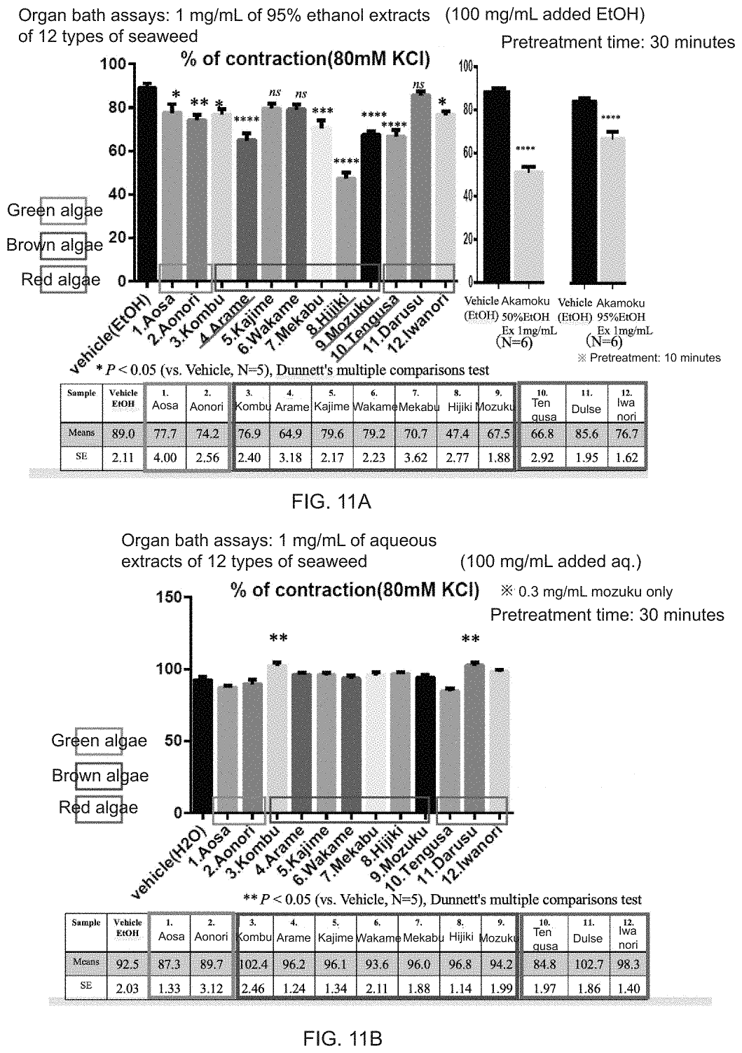

FIGS. 11A and 11B show organ bath assay results from a contractile inhibition experiment for each seaweed. In the graphs in FIGS. 11A and 11B, the x-axis shows unadulterated ethanol as a control, and, in order from the left, aosa and aonori, which are green algae; kombu, arame, kajime, wakame, mekabu, hijiki, and mozuku, which are brown algae; and tengusa, dulse, and iwanori (susabinori; Neopyropia yezoensis, asakusanori; Neopyropia tenera), which are red algae; and the y-axis shows the percentage of contraction induced by 80 mM KCl.

As shown in FIG. 11A, the average contraction compared to 100% uninhibited contraction yielded by 95% ethanol extracts of the 12 seaweed types was 77.7% for aosa, 74.2% for aonori, 76.9% for kombu, 64.9% for arame, 79.6% for kajime, 79.2% for wakame, 70.7% for mekabu, 47.4% for hijiki, 67.5% for mozuku, 66.8% for tengusa, 85.6% for dulse, and 76.7% for iwanori. In particular, arame, hijiki, mozuku, and tengusa significantly inhibited contraction.

As shown in FIG. 11B, the average contraction compared to 100% uninhibited contraction yielded by aqueous extracts of the 12 seaweed types was 87.3% for aosa, 89.7% for aonori, 102.4% for kombu, 96.2% for arame, 96.1% for kajime, 93.6% for wakame, 96.0% for mekabu, 96.8% for hijiki, 94.2% for mozuku, 84.8% for tengusa, 102.7% for dulse, and 98.3% for iwanori, none of which are significant differences; thus, these extracts did not inhibit contraction.

From this, it can be seen that the 95% ethanol extracts of all 12 seaweed types significantly inhibited contraction.

### [Experiment 10] Organ Bath Assay (Contractile Inhibition Experiment for Unsaturated Fatty Acids Present in Akamoku)

Next, the effects upon overactive bladder of each of various fatty acids (EPA, arachidonic acid, stearidonic acid, α-linolenic acid) present in akamoku was investigated via in vitro assay using an organ bath. Specifically, each individual component was analyzed to test whether the component had greater effects upon overactive bladder.

The concentration of each fatty acid was set according to the amount thereof present in a 95% ethanol extract of akamoku (Japan Food Research Laboratories; JFRL quantitative analysis). Specifically, an EPA content of 71 μg/mL, an arachidonic acid content of 44 μg/mL, a stearidonic acid content of 47 μg/mL, and an α-linolenic acid content of 36 μg/mL were set. Ethanol was used as a control. As in the example described above, 80 mM KCl, a contraction inducer, was also added to induce contraction. The tension (contractile force) of slices of rat bladder smooth muscle was then measured to evaluate contraction inhibition effects.

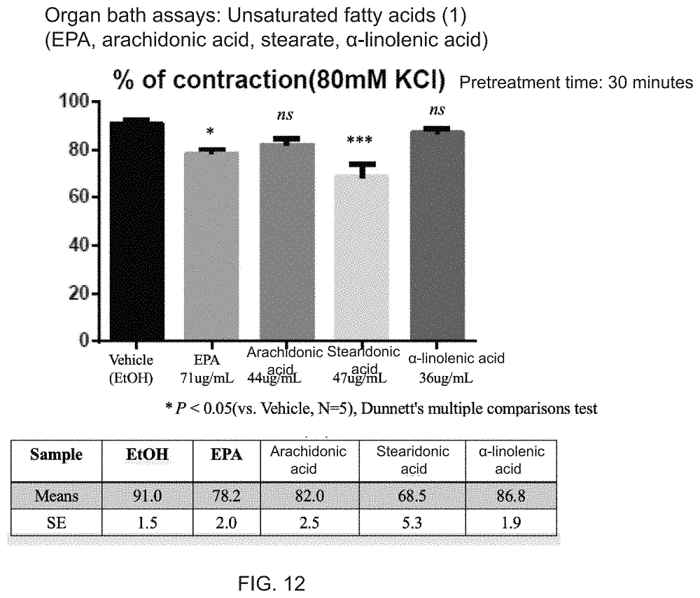

FIG. 12 shows results from a contractile inhibition experiment for substances present in akamoku performed using organ bath assays. In the graph in FIG. 12, the x-axis shows the amounts of ethanol as a control, EPA, arachidonic acid, stearidonic acid, and α-linolenic acid in that order from the left, and the y-axis shows percentage of contraction induced by 80 mM KCl.

As shown in FIG. 12, average contraction compared to 100% uninhibited contraction was 91.0% for ethanol, 78.2% for EPA, 82.0% arachidonic acid, 68.5% for stearidonic acid, and 86.8% for α-linolenic acid. EPA and stearidonic acid in particular significantly inhibited contraction. From these results, it was found that the EPA and stearidonic acid present in the akamoku extract have contraction-inhibitory action.

### [Experiment 11] Organ Bath Assay (Contractile Inhibition Experiment for Combinations of Substances Present in Akamoku)

Next, the effects upon overactive bladder of combinations of the EPA, arachidonic acid, and α-linolenic acid, out of the fatty acids present in akamoku (EPA, arachidonic acid, stearidonic acid, α-linolenic acid), were investigated. Specifically, the additive/synergistic effects of these substances were investigated using different combinations.

The concentration of each fatty acid was set according to the amount thereof present in a 95% ethanol extract of akamoku (JFRL quantitative analysis). A combination of EPA, arachidonic acid, and α-linolenic acid, a combination of EPA and arachidonic acid, and a combination of EPA and α-linolenic acid were compared. Unadulterated EPA was used as a control. As in the examples described above, 80 mM KCl, a contraction inducer, was also added to induce contraction. The tension (contractile force) of slices of rat bladder smooth muscle was then measured to evaluate contraction inhibition effects.

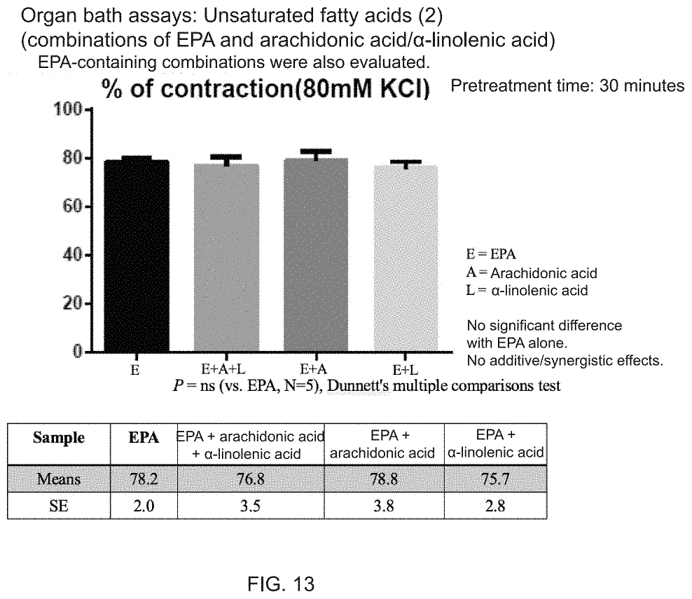

FIG. 13 shows results from a contractile inhibition experiment for combinations of substances present in akamoku performed using organ bath assays. In the graph shown in FIG. 13, the x-axis shows EPA as a control, a combination of EPA, arachidonic acid, and α-linolenic acid, a combination of EPA and arachidonic acid, and a combination of EPA and α-linolenic acid in that order from the left, and the y-axis shows percentage of contraction induced by 80 mM KCl.

As seen in FIG. 13, average contraction compared to 100% uninhibited contraction was 78.2% for EPA, 76.8% for the combination of EPA, arachidonic acid, and α-linolenic acid, 78.8% for the combination of EPA and arachidonic acid, and 75.7% for the combination of EPA and α-linolenic acid. From these results, it was discovered that the various combinations result in no significant difference from EPA alone, and do not have additive/synergistic effects.

### [Experiment 12] Organ Bath Assay Results (Dose-Comparison Contractile Inhibition Experiment for EPA and Stearidonic Acid Present in Akamoku)

This experiment was a repeat of experiment 10 described above with adjusted concentrations of EPA and stearidonic acid, which, among the fatty acids present in akamoku (EPA, arachidonic acid, stearidonic acid, and α-linolenic acid), yielded significant inhibition in that experiment.

The maximum concentration of each fatty acid was set according to the amount thereof present in a 95% ethanol extract of akamoku (JFRL quantitative analysis). Concentrations of 7.1 μg/mL EPA, 21.3 μg/mL EPA, 71 μg/mL EPA, 4.7 μg/mL stearidonic acid, 14.1 μg/mL stearidonic acid, and 47 μg/mL stearidonic acid were set. As in the examples described above, 80 mM KCl, a contraction inducer, was also added to induce contraction. The tension (contractile force) of slices of rat bladder smooth muscle was then measured to evaluate contraction inhibition effects.

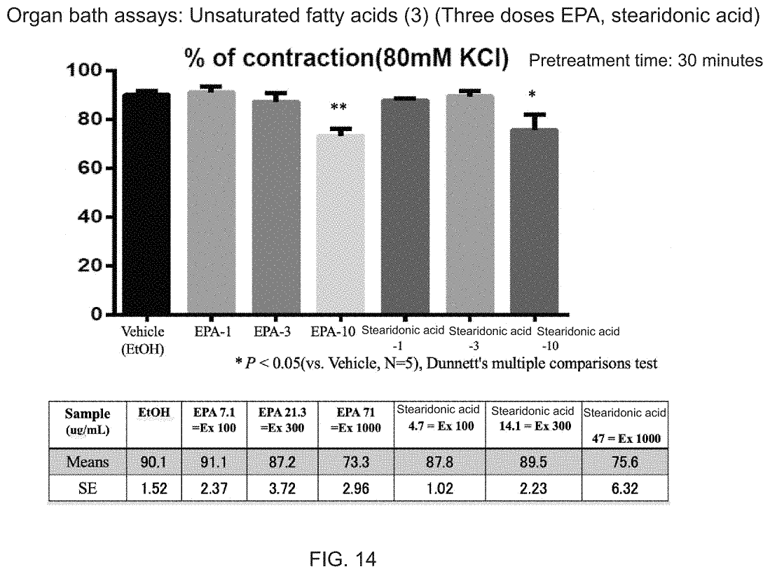

FIG. 14 shows results from contractile inhibition experiments for combinations of substances present in akamoku performed using organ bath assays. In the graph in FIG. 14, the x-axis shows ethanol as a control, 7.1 μg/mL EPA, 21.3 μg/mL EPA, 71 μg/mL EPA, 4.7 μg/mL stearidonic acid, 14.1 μg/mL stearidonic acid, and 47 μg/mL stearidonic acid in that order from the left, and the y-axis shows percentage of contraction induced by 80 mM KCl.

As seen in FIG. 14, average contraction compared to 100% uninhibited contraction was 90.1% for ethanol, 91.1% for 7.1 μg/mL EPA, 87.2% for 21.3 μg/mL EPA, 73.3% for 71 μg/mL EPA, 87.8% for 4.7 μg/mL stearidonic acid, 89.5% for 14.1 μg/mL stearidonic acid, and 75.6% for 47 μg/mL stearidonic acid. From these results, it was found that greater significance was observed as the concentrations of EPA and stearidonic acid increased.

### [Experiment 13] In Vivo Assay Using Acetic-Acid-Induced Pollakiuria Model Rat (Akamoku Extract, 95% Ethanol)

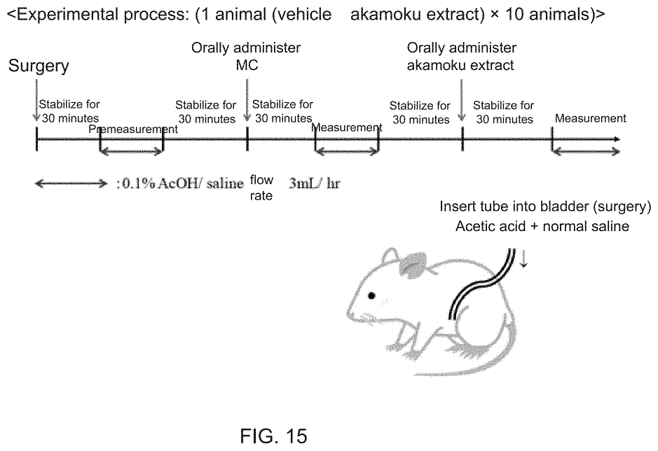

In this experiment, 0.1% acetic acid diluted with normal saline was directly injected into the bladders of urethane-anesthetized rats to induce bladder hypersensitivity and create model rats having symptoms of acute (or chronic) pollakiuria, and in vivo assays were performed using these acetic-acid-induced pollakiuria model rats. As seen in the schematic illustration in FIG. 15, intravesical pressure and volume voided before and after oral administration of a single dose of 50 mg/mL of 95% ethanol extract of akamoku were measured over time via cystometry under urethane anesthesia. In this way, the effects of the 95% ethanol extract of akamoku upon pollakiuric states in rats were investigated.

Voiding function before and after akamoku extract administration (single dose) was compared.

The administration samples were:

control (vehicle)=0.5% methyl cellulose (MC); and
akamoku extract=50 mg/mL MC solution of akamoku extract.

Cystometry parameters were as follows.

### <Cystometry Parameters>

Maximum intravesical pressure (voiding pressure)
Base pressure
Threshold pressure
Voiding interval
Volume per void

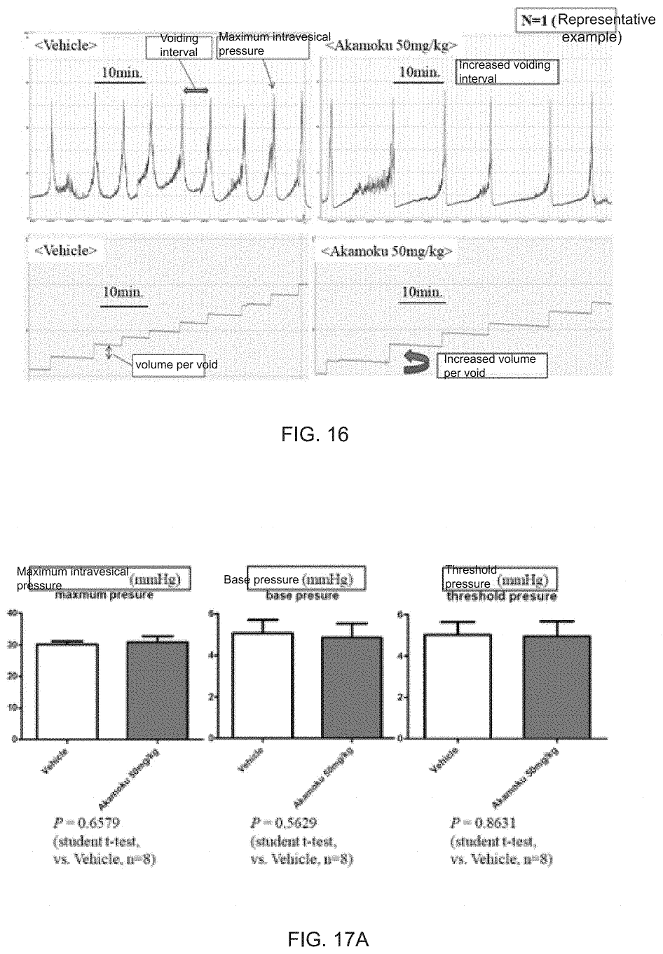

FIG. 16 shows representative examples (maximum intravesical pressure (voiding pressure), volume per void, and voiding interval) of (cystometry) results for effects upon acetic-acid-induced pollakiuria model rats. The individual items of data thus obtained were analyzed, and are stated below.

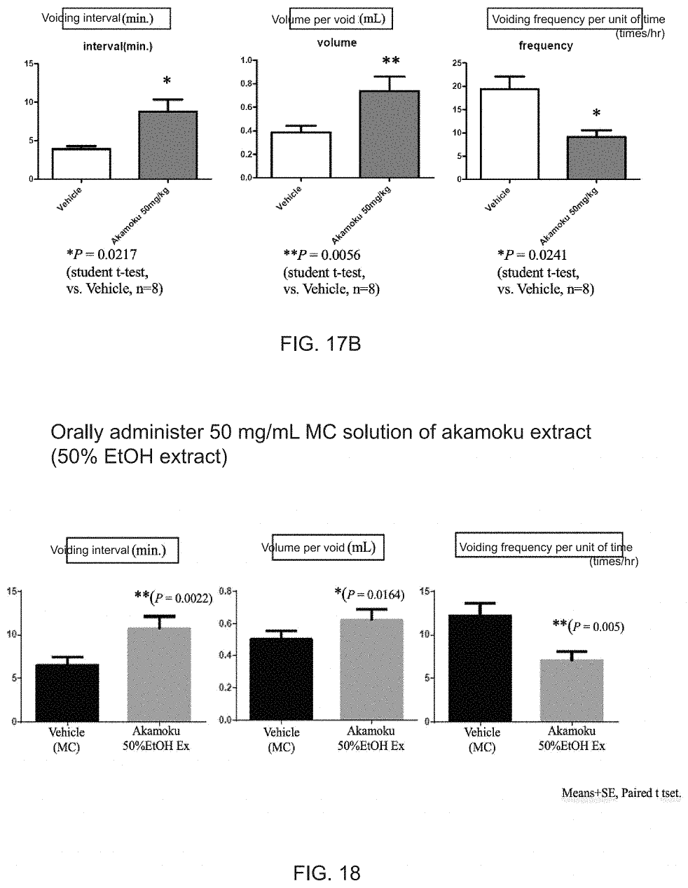

In FIG. 17A, maximum intravesical pressure (mmHg), base pressure (mmHg), and threshold pressure (mmHg) are quantified in that order starting from the graph on the left. In the graphs, the x-axis compares maximum intravesical pressure (mmHg), base pressure (mmHg), and threshold pressure (mmHg) for model rats receiving 50 mg/mL orally administered methyl cellulose (MC) solution of 95% ethanol extract of akamoku with control rats receiving only 0.5% methyl cellulose solution. There were no effects upon maximum intravesical pressure, base pressure, and threshold pressure (mmHg).

In FIG. 17B, voiding interval (min), volume per void (mL), and voiding frequency per unit of time (times/hr) are quantified in that order starting from the graph on the left. On the x-axis in the graphs, the voiding interval of model rats receiving orally administered 95% ethanol extract of akamoku increased from 3.92 minutes to 8.79 minutes compared to control rats receiving 0.5 methyl cellulose (MC) solution. The voiding frequency per unit of time decreased from 19.41 times to 9.14 times/hour. volume per void increased from 0.39 to 0.74 mL. These results show significant improvement of symptoms in pollakiuria model rats receiving orally administered 95% ethanol extract of akamoku.

### [Experiment 14] In Vivo Assay Using Acetic-Acid-Induced Pollakiuria Model Rat (Akamoku Extract, 50% Ethanol)

Using the model rats with symptoms of acute (chronic) pollakiuria created in experiment 13, a 50 mg/mL MC solution of 50% ethanol extract of akamoku was orally administered to the model rats (n=7). In the graphs in FIG. 18, measured parameters are the voiding intervals, volume per void, and voiding frequency per unit of time of the rats, and pollakiuria-symptomatic model rats are compared with control rats receiving 0.5% methyl cellulose (MC) solution. In this way, the effects of the 50% ethanol extract of akamoku upon pollakiuric states in rats are investigated.

In FIG. 18, the voiding interval (min), volume per void (mL), and voiding frequency per unit of time (times/hr) are quantified in that order starting from the graph on the left. In the graphs, the voiding interval of model rats receiving orally administered 50% ethanol extract of akamoku increased from 6.94 minutes to 11.09 minutes compared to control rats receiving 0.5 methyl cellulose (MC) solution. The voiding frequency per unit of time decreased from 11.39 to 6.75 times/hour. The volume per void increased from 0.56 to 0.62 mL. These results show significant improvement of pollakiuria symptoms in model rats receiving orally administered 50% ethanol extract of akamoku.

### [Experiment 15] In Vivo Assay Using Acetic-Acid-Induced Pollakiuria Model Rat (Akamoku Extract, Aqueous)

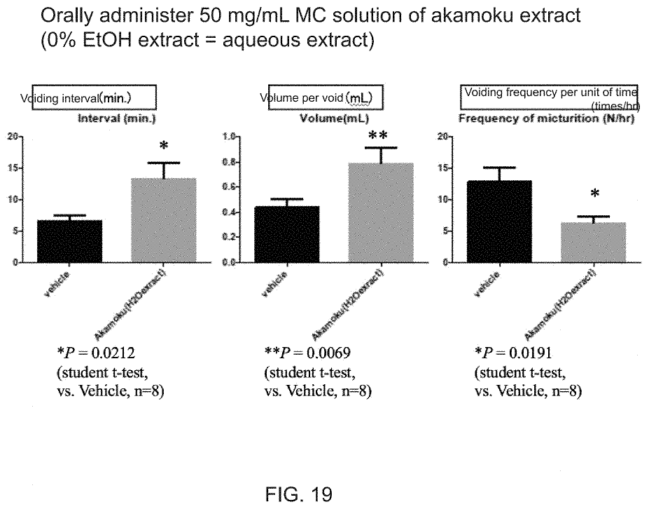

Using the model rats with symptoms of acute (chronic) pollakiuria created in experiment 13, a 50 mg/mL aqueous solution of aqueous akamoku extract was orally administered to the model rats. In the graphs in FIG. 19, measured parameters are the voiding intervals, volume per void, and voiding frequency per unit of time of the rats, compared with control rats receiving ultrapure water. In this way, the effects of the aqueous akamoku extract upon pollakiuric states in rats are investigated.

In FIG. 19, voiding interval (min), volume per void (mL), and voiding frequency per unit of time (times/hr) are quantified in that order starting from the graph on the left. In the graphs, the voiding interval of model rats receiving orally administered aqueous akamoku extract increased from 6.60 minutes to 13.28 minutes compared to control rats receiving 0.5 methyl cellulose (MC) solution. The voiding frequency per unit of time decreased from 12.79 to 6.28 times/hour. The volume per void increased from 0.43 to 0.79 mL. These results show significant improvement of symptoms in pollakiuria model rats receiving orally administered aqueous akamoku extract.

The ethanol extracts of akamoku described above showed efficacy in organ bath assays and cystometric testing; the mechanism of action is hypothesized to be inhibition of bladder smooth muscle contraction mediated by muscarinic receptors present on the cells that make up bladder smooth muscle, or by membrane-depolarizing properties.

By contrast, the aqueous akamoku extract demonstrated no effects in an organ bath assay (FIG. 10C), but did demonstrate effects in cystometric testing.

In other words, the aqueous akamoku extract is hypothesized to have demonstrated improvement of pollakiuria in in vivo cystometric testing through a different mechanism of action than that of the ethanol extract.

There is also the effect that water or hot water extracts can generally be produced more cheaply and easily than ethanol extract. It is hypothesized that effects will be stronger in hot water (approx. 70° C. to 90° C.) than in (unheated) water.

### [Experiment 16] In Vivo Assay (Oral Administration of Akamoku-Derived Fucoxanthin Fx) Using Acetic-Acid-Induced Pollakiuria Model Rats

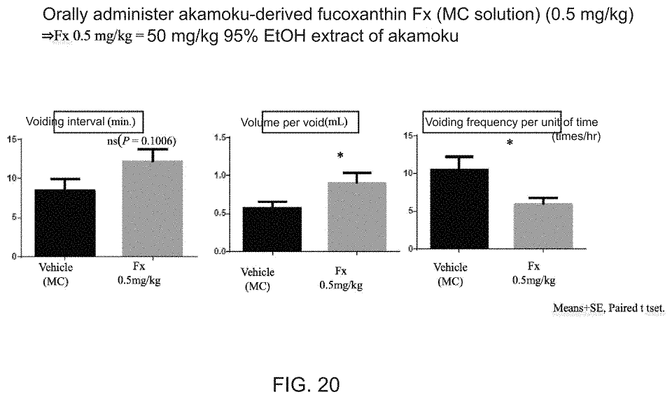

Using the model rats with symptoms of acute (chronic) pollakiuria created in experiment 13, 0.5 mg/kg akamoku-derived fucoxanthin Fx (MC solution) was orally administered to the model rats. The 0.5 mg/kg of akamoku-derived fucoxanthin Fx (MC solution) is equivalent to 50 mg/kg of 95% ethanol extract of akamoku. In the graphs in FIG. 20, measured parameters are the voiding intervals, volume per void, and voiding frequency per unit of time of the rats, compared with control rats receiving 0.5% methyl cellulose (MC) solution.

As seen in FIG. 20, 0.5 mg/kg akamoku-derived fucoxanthin resulted in significant improvement in 0.1% acetic-acid-induced pollakiuria. The volume per void increased, and voiding frequency per unit of time decreased. The voiding interval tended to increase. These results show significant improvement of pollakiuria symptoms in model rats receiving 0.5 mg/kg orally administered akamoku-derived fucoxanthin Fx.

[Experiment 17] In Vivo Assay (50 mg/kg 95% Ethanol Extract of Akamoku) Using CYP-Induced Pollakiuria (Cystitis) Model Rats.

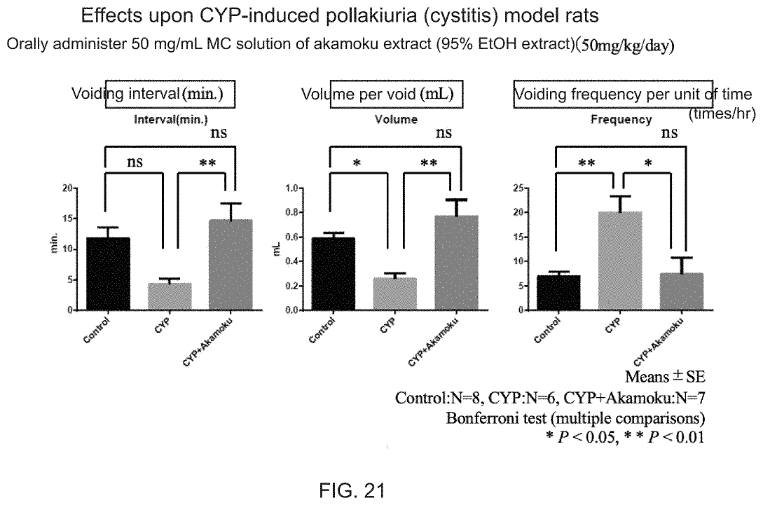

Cyclophosphamide (CYP) was intraperitoneally injected to create CYP-induced pollakiuria (cystitis) model rats, which received 25 mg/kg of orally administered MC solution of 95% ethanol extract of akamoku twice daily (50 mg/kg/day of MC solution of 95% ethanol extract of akamoku). In the graphs in FIG. 21, measured parameters are the voiding intervals, volume per void, and voiding frequency per unit of time of the rats, compared with control rats receiving 0.5% methyl cellulose (MC) solution.

In FIG. 21, the voiding interval (min), volume per void (mL), and voiding frequency per unit of time (times/hr) are quantified in that order starting from the graph on the left. In the graphs, the voiding interval increased from 4.3 minutes to 14.6 minutes in the model rats receiving 50 mg/kg/day of orally administered MC solution of 95% ethanol extract of akamoku, compared to rats receiving CYP. The voiding frequency per unit of time decreased from 20.0 times to 7.4 times/hour. The volume per void increased from 0.26 to 0.77 mL. These results show significant improvement in symptoms of CYP-induced pollakiuria (cystitis) in model rats receiving 50 mg/kg/day orally administered MC solution of 95% ethanol extract of akamoku.

### [Experiment 18] 5α-Reductase Inhibitory Action Experiment (HPLC)

As discussed above, an in vitro assay was performed using high-performance liquid chromatography (HPLC) to observe the inhibitory action of akamoku extract upon 5α-reductase, which convert the prostate-enlarging male hormone testosterone to dihydrotestosterone.

### (5α-Reductase Inhibition Experiment Results 1)

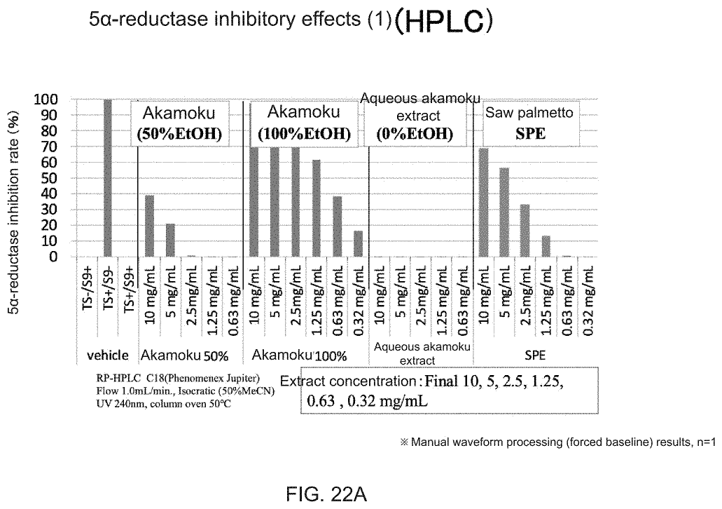

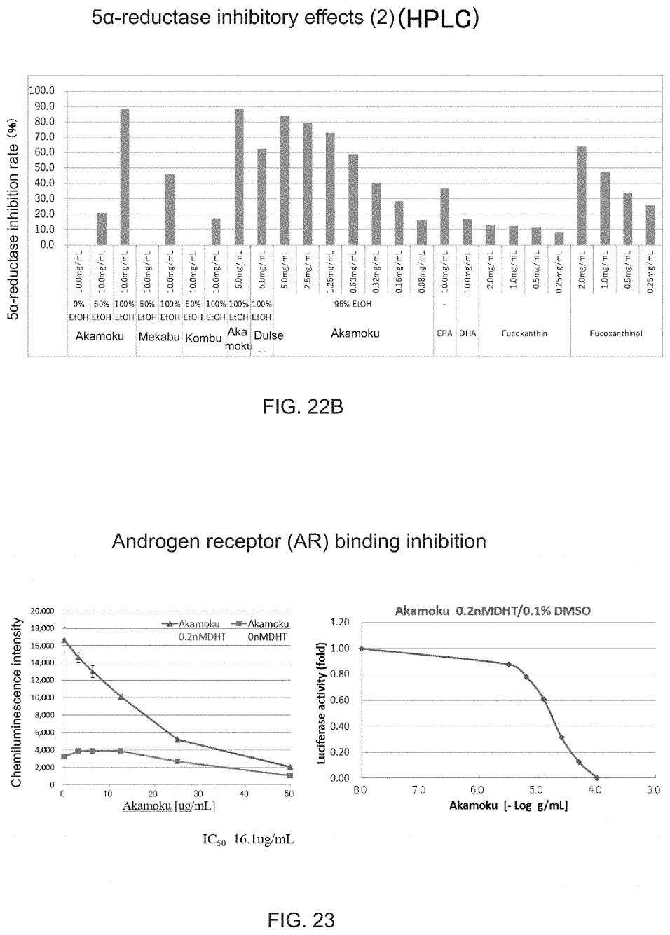

FIG. 22A shows results 1 for a 5α-reductase inhibitory action experiment. Starting from the left, the x-axis compares a control; akamoku extract concentrations of 10, 5, 2.5, 1.25, 0.63, and 0.32 mg/ml, which were extracted with 50% ethanol solution: akamoku extract concentrations of 10, 5, 2.5, 1.25, 0.63, and 0.32 mg/ml, which were extracted with 100% ethanol solution; akamoku extract concentrations of 10, 5, 2.5, 1.25, 0.63, and 0.32 mg/ml, which were extracted with aqueous (0% ethanol); and preparations having respective saw palmetto (SPE) concentrations of 10, 5, 2.5, 1.25, 0.63, and 0.32 mg/ml. The y-axis shows 5α-reductase inhibition rate (%).

Akamoku extract concentrations of 10, 5, 2.5, 1.25, 0.63, and 0.32 mg/ml, which were extracted with 100% ethanol solution, had high inhibition rates. In particular, the 0.32 mg/ml akamoku extract concentration yielding about 18% 5α-reductase inhibition, the 0.63 mg/ml akamoku extract concentration yielding about 39% 5α-reductase inhibition, the 1.25 mg/ml akamoku extract concentration yielding about 61% 5α-reductase inhibition, the 2.5 mg/ml akamoku extract concentration yielding about 78% 5α-reductase inhibition, the 5.0 mg/ml akamoku extract concentration yielding about 91% 5α-reductase inhibition, and the 10.0 mg/ml akamoku extract concentration yielding about 96% 5α-reductase inhibition, showing that inhibition rate increased as akamoku extract concentration increased.

### (5α-Reductase Inhibition Experiment Results 2)

FIG. 22B shows results 2 for a 5α-reductase inhibitory action experiment. The graph presents a comparison by different akamoku ethanol extraction concentrations, and mekabu, kombu, dulse, eicosapentaenoic acid (EPA), docosahexaenoic acid (DHA), fucoxanthin, and fucoxanthinol concentrations. As seen in FIG. 22B, an akamoku extract concentration of 10.0 mg/ml, which were extracted with 100% ethanol solution, yielded about 87% 5α-reductase inhibition, and an akamoku extract concentration of 5.0 mg/ml, which were extracted with 100% ethanol solution, yielded about 87% 5α-reductase inhibition, thus demonstrating quite high inhibition rates. In the akamoku extracts with 95% ethanol solution, the 5α-reductase inhibition rate increased as its akamoku extract concentration increased. It was found that akamoku extract concentrations of 1.25 mg/ml or higher, which were extracted with 95% ethanol solution, have higher 5α-reductase inhibition rates than other types and compounds.

### [Experiment 19] Androgen Receptor (AR) Binding Inhibitory Action Experiment

Next, as described above, an in vitro assay was performed in order to observe akamoku extract inhibitory action upon AR binding, which causes dihydrotestosterone converted by 5α-reductase to effect additional prostate cellular proliferation and hyperplasia.

The AR-EcoScreen Assay system developed by Otsuka Pharmaceutical Factory in order to evaluate AR-mediated antagonistic action was used. Dihydrotestosterone (DHT) that has been converted from testosterone emits chemiluminescence upon binding to AR; thus, a reduction in fluorescent intensity when DHT and a test substance are added in tandem suggests the presence of AR binding inhibitory action. Luciferase activity in a 95% ethanol extract of akamoku containing 0.2 nM DHT and 0.1% DMSO was investigated.

FIG. 23 shows AR binding inhibitory action results. In the plot on the left in FIG. 23, the x-axis indicates the quantity (mg/ml) of akamoku extract, and the y-axis indicates chemiluminescence intensity. The square points are for akamoku extract containing 0 nM DHT, and the triangular points for akamoku extract containing 0.2 nM DHT. Compared to the akamoku extract containing 0 nM DHT, the akamoku extract containing 0.2 nM DHT exhibited a sharp decrease in chemiluminescence intensity, suggesting the possibility that androgen receptor binding is being inhibited. In the plot on the right in FIG. 23, the x-axis indicates the quantity (−log g/ml) of akamoku extract, and the y-axis indicates luciferase activity. Luciferase activity began to decrease around 6.6 −log g/ml, and decreased to 0 at 4.0 −log g/ml.

### [Experiment 20] Results for Cellular Proliferation Suppressant Action Experiment Using Human Prostate Cancer LNCaP.FGC Cells

An in vitro assay was performed to observe cellular proliferation suppressant action in human prostate cancer LNCaP.FGC cells. Specifically, the wells of a 96-well plate were inoculated with human prostate cancer LNCaP.FGC cells to a volume of 1×10⁴ cells/well·100 μL using RPMI 1640 medium containing 10% fetal bovine serum (FBS) and the cells were cultured for 24 hours, after which the medium was replaced with 1% FBS-containing RPMI 1640 containing 0.1 nM, 0.5 nM, 1 nM, 5 nM, 10 nM, 50 nM, and 100 nM dihydrotestosterone (DHT), and containing mixtures of each of these amounts of DHT with 12.5 μg/mL of 95% ethanol extract of akamoku, and culturing was performed for three days, after which the absorbance (measurement wavelength; 450 nm, calibration wavelength; 630 nm) of the culture in the plate in these various conditions was measured using a plate reader.

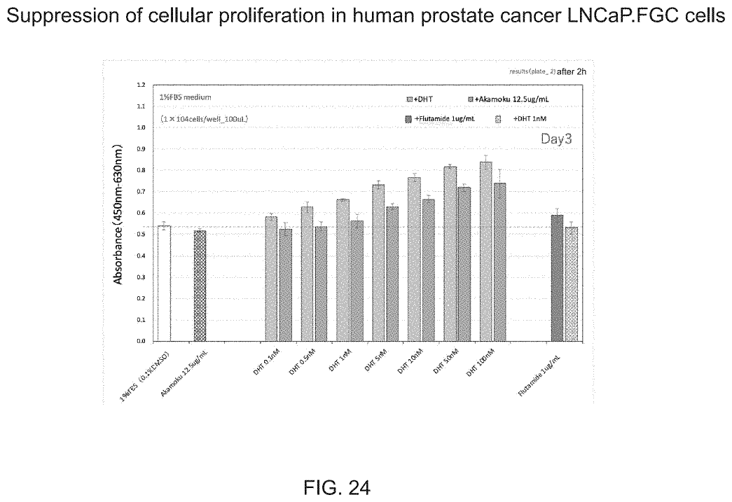

FIG. 24 shows results for a cellular proliferation suppressant action experiment using human prostate cancer LNCaP.FGC cells. In the graph in FIG. 24, the x-axis indicates the quantity (mg/ml) of akamoku extract and DHT, and the y-axis indicates absorbance (450 nm to 630 nm). In other words, a high level of absorbance indicates that there was much human prostate cancer LNCaP.FGC cell proliferation, and a low level indicates that cellular proliferation was suppressed.

As shown in the graph in FIG. 24, the addition of 12.5 μg/mL akamoku extract resulted in lower absorbance than that exhibited by dihydrotestosterone (DHT) alone at every DHT concentration of 0.1 nM, 0.5 nM, 1 nM, 5 nM, 10 nM, 50 nM, and 100 nM, indicating that the cellular proliferation of the human prostate cancer LNCaP.FGC cells had been suppressed.

### [Experiment 21] Drug Efficacy Evaluation Experiment Using Rat Benign Prostatic Hyperplasia Model

An experiment for in vivo drug efficacy in a rat benign prostatic hyperplasia model was performed using model rats in states of benign prostatic hyperplasia. The model rats received 60 mg/kg/day of 95% ethanol extract of akamoku. For the control, the model rats received a 0.5% methyl cellulose solution. This regimen was continued for 28 days, after which the prostates were removed from the rats and measured.

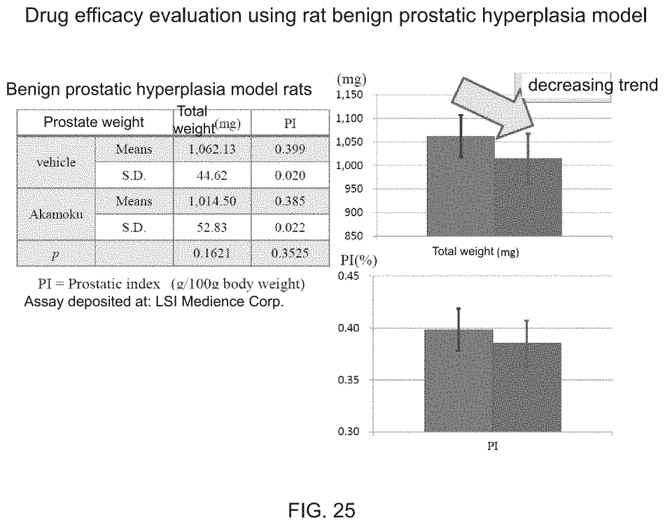

FIG. 25 shows results for a drug efficacy evaluation experiment using a rat benign prostatic hyperplasia model. The table on the left in FIG. 25 presents total benign prostatic hyperplasia weight (mg) in the model rats following the dosing regimen; PI indicates prostatic index. The right graphs on FIG. 25 compares the total prostatic hyperplasia weight and PI. Referring to the table and graphs, it was found that the average total prostate weight was 1,062.13 mg (PI: 0.399) in rats receiving the control regimen, as opposed to 1,014.50 mg (PI: 0.385) in rats receiving akamoku extract, demonstrating a downward trend.

While the foregoing has been a description of an embodiment of the present invention, the present invention is not limited thereto, and various modifications may be made thereto to the extent that they do not depart from the gist of the invention.

While akamoku extract is used in the functional supplement of the embodiment described above, a seaweed other than akamoku may be used, as it has been confirmed that any seaweed extract that is abundant and easily utilized will exhibit effects comparable of those of akamoku, arame, hijiki, mozuku, and tengusa are particularly well-suited in terms of availability and abundance.

1. A functional supplement for preventing or improving of overactive bladder, wherein the functional supplement contains a seaweed extract, and wherein the seaweed is one seaweed selected from the group consisting of aosa (Ulva), aonori (green laver), kombu, arame (Eisenia bicyclis), kajime (Ecklonia cava), wakame (Undaria pinnatifida), mekabu (root of the wakame), hijiki (Sargassum fusiforme), mozuku (Nemacystus decipiens), tengusa (red algae in family Gelidiaceae), dulse, iwanori (various species of Pyropia), and akamoku (Sargassum horneri).

2. (canceled)

3. (canceled)

4. The functional supplement according to claim 1, wherein the seaweed extract is extracted from a specific seaweed in at least 50% ethanol solution.

5. The functional supplement according to claim 4, wherein the seaweed extract is extracted from a specific seaweed in at least 95% ethanol solution.

6. The functional supplement according to claim 1, wherein the seaweed extract has an extract concentration of 300 μg/mL or greater.

7. The functional supplement according to claim 6, wherein the seaweed extract has an extract concentration of 1 mg/mL or greater.

8. The functional supplement according to claim 1, wherein the seaweed extract has a fucoxanthin concentration of at least 0.5 mg/Kg, an eicosapentaenoic acid concentration of at least 71 μg/mL, and a stearidonic acid concentration of at least 47 μg/mL.

9. The functional supplement according to claim 1, wherein the seaweed extract is water extracted or hot water extracted from a specific seaweed.

10. The functional supplement according to claim 1, wherein the seaweed extract has an extract concentration of 50 mg/mL or greater.
